(19) United States
(12) Patent Application Publication
(10) Pub. No.: US 2009/0168762 A1
(43) Pub. Date: Jul. 2, 2009

(54) Method and System for Setting Up a Voice Connection

(75) Inventors: Evert Jaap Lugt, Rotterdam (NL); Jeroen Verdonk, Zeist (NL); Martin Smink, Brielle (NL); Jan Gerard Snip, Zoeterwoude-Dorp (NL)

Correspondence Address: SWANSON & BRATSCHUN, L.L.C., 8210 SOUTHPARK TERRACE, LITTLETON, CO, 80120, US

(73) Assignee: NIMBUZZ B.V., Capelle aan den Ijssel (NL)

(21) Appl. No.: 12/297,559

(22) PCT Filed: Apr. 17, 2007
(86) PCT No.: PCT/NL07/50157

§ 371 Date: Mar. 6, 2009

(30) Foreign Application Priority Data
Apr. 18, 2006 (NL) 1031604

(51) Int. Cl. H04L 12/66

(52) U.S. Cl. 370/352

(57) ABSTRACT

Method for setting up a voice connection between a first terminal set (T1), arranged for the transfer of IP data (c) and of non-VoIP voice signals (v1) via a non-VoIP voice network (N1), and a second terminal set (T2). By the first terminal set (T1) a voice connection is initiated utilizing an interconnection system, (DS) which are arranged to exchange IP data (c) for setting up the desired voice connection with the non-VoIP voice network (N1) and the VoIP voice network (N2). The interconnection system (DS) is arranged for setting up, by means of the IP data (c), a first partial voice connection with the first terminal set (T1) via the non-VoIP voice network (N1) and of one or more further partial voice connections with the second terminal set (T2), and for coupling through the first and the one or more further partial voice connections.

### FIELD

The invention concerns a method or system respectively for setting up a voice connection between a first terminal set, which is arranged for not IP (Internet Protocol) based voice traffic (non-VoIP) and IP data traffic at a low bitrate, and a second terminal set which is or is not arranged for IP (with a relative high bitrate) based voice traffic (VoIP) or IP data traffic respectively.

Particularly—however, not exclusively—the invention concerns a method or system respectively for setting up a voice connection between a mobile terminal set, e.g. a modern GSM terminal set, which is not pre-eminently arranged or suitable for VoIP voice, but which is arranged or suitable indeed for exchanging IP data at a low bitrate, and another, second terminal set, which is pre-eminently arranged or suitable for VoIP voice, like e.g. a PC which, via ADSL or another broadband medium, is connected with the Internet. Moreover, the invention concerns setting up connections between other terminal sets.

### BACKGROUND

For long-distance voice connection more and more frequently use is made of VoIP voice (speech) solutions. VoIP voice, however, does not work when using the present, popular standard mobile telephone sets (GSM). It does work with mobile telephone sets which use UMTS; UMTS, however, is still very expensive and is not widespread.

Addressing within Instant Messaging (IM) and (standard) VoIP-to-VoIP voice often occurs on the basis of labeled IP addresses, called buddies. Users know and recognize their relatives, friends and acquaintances as their buddies, and it would be convenient—what would be one aim of the present invention—if, in addition to services like IM and VoIP voice, also other, non-VoIP communication forms (e.g. based on GSM or POTS), could make use of this way of addressing.

### SUMMARY

An important aim of the invention is providing a coupling between a first terminal set and a second terminal set, utilizing the possibilities offered by the Internet, even when one or both terminal sets are not arranged or suitable in themselves for voice via the Internet (VoIP). A further aim of the invention is that such terminal sets, which are not suitable for VoIP (IP voice/speech), nevertheless are enabled to set up connections by using a list of buddies or users having IP addresses (IP data).

For the realization of those aims the invention—roughly formulated—provides that IP data connections, having a rather low bitrate, may be used to set up a voice connection between terminal sets of which either one or both are not arranged for VoIP (which requests a high bitrate); that for voice traffic where necessary a non-VoIP partial voice connection (e.g. via the GSM network) but where possible a VoIP partial voice connection (via the Internet) will be set up; which partial voice connections (e.g. GSM—VoIP) subsequently are interconnected, thus realizing a complete voice connection between both terminal sets. In such a configuration an aim will be, for the voice connection, to utilize the Internet, i.e. VoIP, as much as possible.

Formulated more formally, the invention comprises a method for setting up a voice connection between a first terminal set which is arranged for the transfer of IP based control data at a low bitrate, hereinafter indicated with IP data, via a connection which is arranged for such IP data, hereinafter indicated with IP data connection, and for the transfer of non-VoIP voice signals via a network which is arranged for such a non-VoIP voice signals, e.g. a GSM or POTS telephony network, hereinafter indicated with non-VoIP voice network, which thus, due to the restricted bandwidth, is not arranged for voice via IP, and a second terminal set, which is arranged for the transfer of IP data and of either VoIP voice signals via a network which is arranged for such VoIP voice signals, e.g. the (broadband) Internet, hereinafter indicated with VoIP voice network, either of non-VoIP voice signals via the (or another than the first mentioned one) non-VoIP voice network, wherein, by the first terminal set or by the second terminal set a voice connection between both terminal sets is initiated by utilizing an interconnection system, comprising one or more interconnection servers, which interconnection system is arranged
to exchange IP data, relevant for setting up the voice connection between the first and second terminal set;
for setting up, by means of those IP data, a first partial voice connection between the first terminal set and the interconnection system via the non-VoIP voice network;
for setting up, preferably by means of those IP data, one or more further partial voice connections between the interconnection system and the second terminal set via the VoIP voice network and/or the non-VoIP voice network,
and for coupling through or interconnecting the first and said one or more further partial voice connections.

Different situations may occur which—based on the preceding—may be elaborated in somewhat different ways. Diverse actions in setting up the voice connection and diverse relevant options will be discussed hereinafter. The sequence of the actions may differ from the order in which they will be mentioned (A., B., C. etc.) and discussed below.

A. Via an IP data connection—at a low bitrate—the first terminal set passes to the interconnection system its own, first IP address (IP1), as well as a second IP address (IP2), belonging to the second terminal set to be called; both IP addresses are, linked to each other (IP1-IP2), stored into the interconnection system. Further below the situation will be discussed in which the second terminal set does not have an IP address.

B. Of the first terminal set—at any moment—in the interconnection server its IP address (IP1) is stored linked to a network address (NA1) which is valid for the non-VoIP voice network and which is—temporality or permanently—characteristic for that first terminal set. Both addresses are, linked to each other (IP1-NA1), stored into the interconnection system. This action may precede action A. or may be performed after, partly dependent of what will be used as a characteristic network address.

The characteristic network address may be the own (usually permanent) telephone number (“A-number”) of that first terminal set, which can be recognized by the interconnection system by means of CLI (Calling Line Identification), or a telephone number that the interconnection server itself makes available (e.g. temporarily) as a call number (“B-number”) and, via IP data, passes to the first terminal set in order to arrange that it can be called by the first terminal set for setting up the first partial voice connection, i.e. between that first terminal set and the interconnection system. Under D. the characteristic network address will be discussed more in detail.

### B′. Optionally

If, like the first terminal set, also the second terminal set only be can reached via the (or a) non-VoIP (telephone) network (e.g., the second terminal set is, like the first terminal set, a GSM set too), for that second terminal set the combination of IP address (IP2)—characteristic (telephone) network address (NA2) is linked (IP2-NA2) en stored into the interconnection system. Also here the characteristic network address can be the telephone number (“A-number”) of that second terminal set or a special to be called (by that second terminal set) number (“B-number”) in order to reach the interconnection server.

C. The characteristic non-VoIP-network address (NA1) of the first terminal set, stored in connection with the first terminal set's IP address (IP1), is stored by the interconnection system, linked with the IP address of the second terminal set (IP2) towards which a connection is desired (NA1-IP2). In other words, the IP address of the first terminal set (IP1) is, by the interconnection server, converted into or replaced by the characteristic non-VoIP network address which is valid for that terminal set, in other words, its characteristic telephone number (NA1).

### C′. Optionally

When—as mentioned under ‘B’. Optionally”—also the second terminal set is accessible via the (or a) non-VoIP network, also for that terminal set, from the previously stored (linked) data pair IP address—characteristic (telephone) network address (IP2-NA2), the IP address of the second terminal set is converted into or replaced by the non-VoIP network address which is characteristic for that terminal set, so that, in this optional case, the characteristic non-VoIP network address of the first terminal set is linked, by the interconnection system, with the characteristic network address of the second terminal set (NA1-NA2).

D. Via IP data the interconnection system subsequently passes to the first terminal set that this must/may call the interconnection system for realizing the first partial voice connection, i.e. the one between the first terminal set and the interconnection system. For setting up this partial voice connection use is made of the characteristic telephone number (NA1) of that first terminal set. There are—as mentioned before—two options possible:

a. The characteristic network address may be formed by the A-number, i.e. the telephone number of the terminal set. In this option the B-number, i.e. the telephone number of the interconnection system which to be called by the terminal set is therefore not-characteristic for that first terminal set. It can be that e.g. there is known a generally (e.g. 0900) number at the side of the first terminal set, which has to be called. It may also be that the number to be called (B-number) is communicated to the first terminal set via IP data (which will be preferred), where it is either displayed on the screen of the terminal set, or where it is read in by software which has been installed in the first terminal set for the benefit of the present service, so that the user of the first terminal set, by means of only one “press of the button” (or even without), can set up the partial voice connection to the interconnection system. In this option the characteristic telephone number of the first terminal set is formed by its own telephone number, assigned, at the time, by its telephone provider. In that case that telephone number must have been stored in the interconnection system at any previous moment in accordance with the step mentioned under B. (see above). When the first terminal set thus calls—for setting up the first partial voice connection—the interconnection system, the interconnection system has to detect which first terminal set is involved with that call (after all, in practice the interconnection system will, more or less at the same moment, have to process several different calls from the non-VoIP (read: telephone) network) by means of detecting the telephone number of that first terminal set, using CLI (Calling Line Identification).

b. The characteristic network address may also be formed by the B-number, i.e. the telephone number of the interconnection system which the terminal set has to call. In this option no use is made of detection of the (permanent) A-number (CLI)—there exist, after all, systems and/or situations in which CLI cannot be utilized—, but the first terminal set is characterized, at any moment, by a temporary B-number which is assigned to the first terminal set by the interconnection system. In this case it is—via IP data—passed to the first terminal set which specific telephone number (B-number) the first terminal set has to call for setting up of the partial voice connection between the first terminal set and the interconnection system. In this option the value of the characteristic telephone number is thus originating from the interconnection system. That number will have a restricted “storage life”. Thus under par. B (see above) the IP address of the first terminal set (IP1) and the call number of the interconnection system, determined by the interconnection system and usable for a restricted period, are stored. For making the partial voice connection to the interconnection system, the first terminal set thus calls the relevant, to be used only for that connection and characteristic, call number of the interconnection system. Obviously, that characteristic call number has, at any moment, to be passed to the first terminal set. From all—in practice—more or less simultaneous calls originating from the telephone network, the interconnection system thus can determine, from the value of the telephone number (of the node) at which the call enters—the B-number—which is specific for the first terminal set. Also in this case the relevant—but characteristic and temporary now—telephone number may, by means of IP data, be displayed on the screen of the first terminal set, or—and preferably—be used by the software of the first terminal set to set up (semi-)automatically the partial voice connection. After the partial voice connection between the first terminal set and the interconnection system has been finished, the temporary characteristic B-number will be released again for other partial voice connections. When the first terminal set does not set up the partial voice connection within the relevant “storage life period”, the temporary characteristic B-number will be released and the first terminal set will be informed about that via IP data.

E. When the second terminal set is a VoIP enabled terminal set, the second partial voice connection between the interconnection system and the second terminal set can be initiated starting from the interconnection system according to the standard VoIP protocol, under control of (its own IP address and) the IP address of the second terminal set (IP2). By which the second partial voice connection thus will be realized.

### E′. Optionally

What was explained in the preceding under D. about the partial voice connection between the first terminal set and the interconnection system (via the non-VoIP network), can, mutatis mutandis, be used in the same way for setting up a—second—partial voice connection between the interconnection system and the second terminal set in the case that—see under B′ and C′—also the second terminal set, just like the first terminal set, is accessible via a/the non-VoIP (e.g. GSM) network and also for that terminal set use is made of a (telephone) network address (NA2) which is characteristic for that second terminal set, which (see under B′.) is stored into the interconnection system. Also for setting up that second partial voice connection thus use can be made of a characteristic A-telephone number (option a.) or a characteristic B-telephone number (option b.).

F. Finally, after both partial voice connections—the first one between the first terminal set and the interconnection system and the second one between the second terminal set and the interconnection system—have been established, the interconnection system couples both partial voice connections to one voice connection between the first and the second terminal set, after which the user of the first and second terminal set can talk with each other. After disconnecting the voice connection, starting from the first or the second terminal set, also the interconnection system disconnects the partial voice connections which are not necessary any longer and removes temporary parameters, like a possibly temporary characteristic B-number, assigned to the first terminal set, and possibly a temporary characteristic B-number, assigned to the second terminal set. Permanent parameters, like characteristic A-numbers (after all having a permanent character in most cases) of the first or second terminal set respectively, may, if desired, remain stored in the interconnection system for future connection sessions.

Some additional options will be discussed now, which may be important within the scope of this invention.

In a preferred embodiment according to the invention, the first terminal set passes via an IP data connection to the interconnection system its own, first IP address (IP1), as well as a second IP address (IP2) belonging to the second terminal set to be called and/or a network address (NA2) which is valid for the non-VoIP voice network and which is characteristic for the second terminal set to be called, the first IP address (IP1) as well as the second IP address (IP2) and/or the network address (NA2) are, linked to each other, stored into the interconnection system (IP1-IP2); (IP1-NA2).

In a further preferred embodiment according to the invention, the interconnection system passes via IP data to the first and/or second terminal set enabling the first and/or second terminal set, respectively, to call the interconnection system for effecting the first and/or second partial voice connection, respectively, between the first and/or second terminal set, respectively, and the interconnection system; for setting up the one or more partial voice connections, use is made of the characteristic network address (NA1; NA2) of the first and/or second terminal set, respectively.

In an additional preferred embodiment according to the invention, the interconnection system brings about said first and/or second partial voice connection with the first and/or second terminal set, respectively, via a VoIP network, or via said or another non-VoIP voice network.

In a yet further preferred embodiment according to the invention, the interconnection system passes via IP data to the first or second terminal set enabling the first and/or second terminal set, respectively, to call the second or first terminal set, respectively for effecting a direct voice connection between the first and second terminal set via said non-VoIP network; the first and/or second partial voice connection, respectively, between the first and/or second terminal set, respectively, and the interconnection system; for setting up the one or more partial voice connections, use is made of the characteristic network addresses (NA1; NA2) of the first and second terminal set.

It is noted that instead of or in addition to establishing a voice connection, a video connection can be established. In this context, a voice connection means a connection for contacting multiple users via voice, such as speech, music, etc. In principle, the terminal set type is not limited to a conventional telephone terminal or a mobile phone, but can also be a computer or server provided with sound input and output means, such as a microphone and a speaker set. Therefore, the voice connection can be extended to a particular user, using various services, e.g. a common telephone connection or Internet embedded services, such as chatting, or web-based social communities.

Further, the method according to the invention can be used to arrange an interconnection between more than two terminal sets, e.g. three or four or more terminals sets, thereby generating a conference interconnection or a so-called group call.

When the second terminal set is arranged for the transfer of VoIP voice signals via the VoIP voice network and those second (VoIP enabled) terminal set wants (the other way about than above) set up a connection to the (non-VoIP enabled) first terminal set, two options are possible:

a. The second terminal set may, via IP data, request the first terminal set to set up a connection to the second terminal set. With it that connection can be set up subsequently as elaborated hereinabove, as, after all, the connection—after having been provoked thereto by the second terminal set—starts from the first terminal set and, using the interconnection system, will be set up to the second terminal set.

b. Another option is not to address the request for setting up a connection to the first terminal set but—via IP data—directly to the interconnection system. Which then—if provided with the relevant parameters, supplied by the second terminal set or already obtained during an earlier session with the relevant first terminal set—will set up a partial voice connection with that first terminal set and couple it with a VoIP partial voice connection with the (in this case) initiating second terminal set.

When the second terminal set, just like the first terminal set, is arranged for non-VoIP voice signals via the non-VoIP voice network, in other words, when neither terminal set is arranged for VoIP, the terminal sets, as already mentioned in the preceding, under B′, C′ and D′ (“Optionally”), may be connected one another by (under B′) linking, also for the second terminal set (just as for the first terminal set), the IP address (IP2) with a (telephone) network address which is characteristic for the second terminal set, and storing that into the interconnection system (IP2-NA2). The characteristic network address may be the telephone number (A-number) of that second terminal set or a special number (B-number) to be called by the second terminal set, of the interconnection server (temporarily reserved by the interconnection server), as discussed in detailed in the preceding. Subsequently, also for the second terminal set, from the stored link (IP2-NA2) the IP address of the second terminal set is converted (under C′) into or replaced by the non-VoIP network address which is characteristic for that terminal set, so that, by the interconnection system, the characteristic non-VoIP network address of the first terminal set is linked with the characteristic network address of the second terminal set (NA1-NA2), with which the interconnection system is able to set up a partial voice connection with the first terminal set and a partial voice connection with the second terminal set, utilizing both characteristic network addresses (A- or B-numbers) (NA1-NA2) and to couple both partial voice connections. This optional method thus is suitable for the situation that neither terminal set is VoIP enabled indeed, but that both, by means of IP data, can use each other's IP addresses with the help of a list of buddies or users having IP data; e.g. both terminal sets may be “state-of-the-art” GSM telephone sets.

When, however, neither of both terminal sets is arranged for VoIP (in other words neither of both terminal sets is VoIP enabled) and, besides, only one, only the first terminal set is IP data enabled and has an own IP address, while the second terminal set is e.g. a somewhat older, not IP data enabled GSM or (even) a conventional POTS telephone apparatus, the method according to the invention may nevertheless be performed, however, adapted as follows:

In that case, in the action A. mentioned hereinabove, the IP address of the second terminal set will not be entered—since the second terminal set does not have an IP address as it is not IP enabled—but, instead, a characteristic network address (NA2) of the second terminal set will be entered. In this situation, the first (IP enabled) terminal set either will have to have entered e.g. the telephone number (NA2) of the terminal set to be called in its list of buddies or users, or will have to enter (to key in) that telephone number manually, in order to initiate a connection with that second terminal set. Under action A. then the IP address (IP1) of the first terminal set and the network address (NA2) of the second terminal set thus will be linked to each other (IP1-NA2) and stored into the interconnection server.

Under action B. then the IP address (IP1) of the first terminal set will be stored, linked (IP1-NA1) to its characteristic network address (NA1). Based on that, the interconnection system may request the first terminal set, via IP data, to set up a voice connection to the interconnection system via the non-VoIP network (e.g. GSM), the interconnection system makes, via the (relevant) non-VoIP network a partial voice connection with the second terminal set (NA2) and couples both partial voice connections to each other.

In the preceding there always has been spoken of a (first of second respectively) terminal set instead of, e.g., a (first of second respectively) terminal. This item will be discussed now.

The first terminal set or each of both terminal sets may comprise a module which is arranged for non-VoIP voice signals—therefore not arranged for VoIP voice signals—, as well as a module which is arranged for IP data. For instance, the first terminal set is or both terminal sets are “state-of-the-art” GSM telephone sets, not arranged for VoIP voice indeed—requiring a large bandwidth or transmission rate—but which is arranged, via a built-in IP data module, for exchanging IP data including IP addresses), as a result of which lists of buddies or users may be utilized. In this option the module arranged for non-VoIP voice signals and a module arranged for IP data thus are physically located within the same terminal. Particularly the terminal set may be formed by a telephony terminal, e.g. a modern GSM telephone set.

The first terminal set or each of both terminal sets may comprise a telephony terminal which is arranged for non-VoIP voice signals—unsuitable (not arranged) for VoIP voice signals—which, however is also neither arranged for IP data, in other words a telephony terminal which is not suitable/arranged at all for any form of IP, e.g. an older GSM set or a conventional POTS telephone device. This deficiency, however, may be compensated by having the terminal set to consist of the telephone device which is not suitable/arranged for IP, together with a computer terminal (“PC”) which is suitable/arranged for IP data. With the latter then, e.g. using a list of buddies or users installed at that PC, via IP data a voice connection between both telephone devices may be initiated which partly goes via the non-VoIP network (e.g. GSM or POTS), partly via the IP network (e.g. the Internet or an Intranet).

The entire connection—to be set up via IP data—e.g. may schematically look like this:

terminal A (non-VoIP)<->telephony network A (non-VoIP)<->interconnection server A (non-VoIP/VoIP)<->Internet (VoIP)<->interconnection server B (VoIP/non-VoIP)<->telephony network B (or A) (non-VoIP)<->terminal B (non-VoIP).

In this diagram interconnection server A and interconnection server B are considered to belong to one interconnection system, in this case, however, distributed over two servers, viz. the servers A and B. Especially when terminal A and terminal B are located in the vicinity of each other, the interconnection system may be formed by one interconnection server, having one coupling unit. However, when terminal A and terminal B are located at a larger geographical distance from each other, the interconnection system may be formed by separate—separated physically and geographically from each other—cooperating coupling units, in separate interconnection servers A and B, which may be interconnected by means of the VoIP network (the Internet).

Besides the method as presented in the preceding, the invention also comprises a system arranged for performing that method according the invention. An exemplary embodiment of such a system will be discussed hereinafter, referring to some figures.

### EXEMPLARY EMBODIMENT

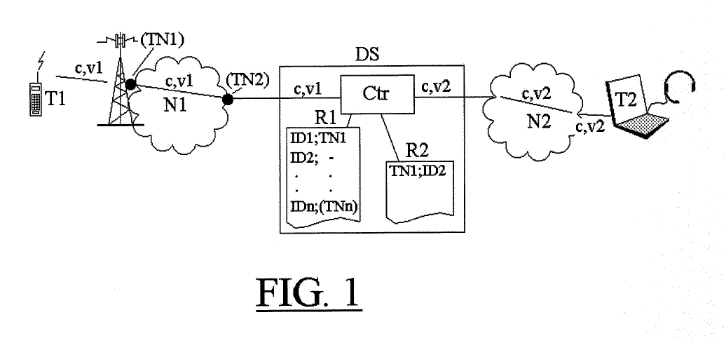

FIG. 1 shows an exemplary embodiment of a system that is arranged for performing the method as discussed hereinabove.

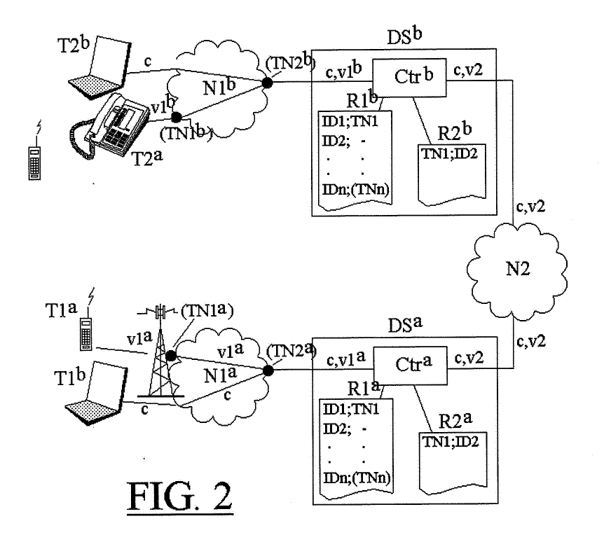

FIG. 2 shows a second exemplary embodiment of such a system arranged for performing the method as discussed hereinabove.

FIG. 1 shows a system for setting up a voice connection between a first terminal set T1 and a second terminal set T2. Terminal set T1 is suitable for the transfer of non-VoIP voice signals v1, e.g. GSM, and IP data c at a low bitrate, via a first network N1, in this case a public GSM network.

Terminal set T2 is suitable for the transfer of VoIP voice signals v2 (VoIP) and IP data c via a VoIP voice network N2, e.g. the Internet. The shown system, moreover, comprises an interconnection server DS which is arranged for initiating, via an IP data connection (c) at a low bitrate between the first terminal set and the second terminal set, a voice connection (v1-v2) between that first and second terminal set. The interconnection server DS is provided with among others a control unit Ctr for the exchange of the relevant control data c for setting up the desired voice connection (v1-v2) between the first and second terminal set, between the non-VoIP voice network N1 at one side and the VoIP voice network N2 at the other side.

The control unit Ctr provides, together with a first register R1 and a second register R2, for setting up, by means of the IP data c, a first voice connection v1 through the non-VoIP voice network N1, between the first terminal set T1 and the interconnection server DS. Moreover, the control unit Ctr provides, together with the first and second register, for setting up, by means of the IP data c, of a second voice connection v2 through the VoIP voice network N2 between the interconnection server DS and the second terminal set T2 and, finally, for coupling through the first voice connection v1 and the second voice connection v2.

As mentioned, the interconnection server DS comprises a first register R1, arranged for storing, for the first terminal set, a first IP address IP1 and with that a (or the) valid network address (“GSM telephone number”) TN1 of that first terminal set at the non-VoIP voice network (“IP1; TN1”), as well as, for the second terminal set, a second IP address IP2 (without telephone number: “IP2; —”).

The interconnection server DS is—by means of the control unit Ctr—arranged to receive from that first terminal set T1 the value of its IP address IP1 as well as the value of the IP address IP2 of the second terminal set, when the first terminal set T1—via an IP data connection—desires to set up a voice connection with the second terminal set. Terminal set T1 may e.g. pass IP1 and 1P2 to the interconnection server DS in that the user of the terminal set T1 uses his/her list of buddies or users stored in a memory of terminal set T1. IP1 and IP2 are, e.g., the IP addresses of T1 and T2.

It is noted that a list of buddies or users is a table comprising a multiple number of user names wherein a user name is linked to one or more corresponding IP addresses, one or more identifications in a database in a particular Internet domain, such as name@domainname.com, and/or one or more corresponding network addresses of a non-VoIP voice network. The state of a user or buddy can e.g. be online or offline. Online means that there is a live IP data connection to the interconnection server DS. Offline means that the IP data connection has been terminated.

The control unit Ctr is arranged to retrieve from the first register R1 the first terminal set's network address TN1 (the telephone number) at the non-VoIP voice network N1 (the telephone network), belonging to the first terminal set's IP address IP1.

The network address TN1 of terminal set T1 at the non-VoIP voice network N1, retrieved in the register R1 based on the received first IP address IP1, is temporarily (e.g. for a period p) stored in a second register R2, together with the IP address IP2 of the terminal set T2 to which a connection has to be set up: register R1 then thus contains a record having the content “TN1;IP2”.

The interconnection server DS is arranged—by means of the control unit Ctr—to pass, via an IP data connection (c) with a low bitrate, to the first terminal set T1 a network address TN2 valid for the non-VoIP voice network, e.g. a 0800 or 0900 number established for that. This may be a telephone number which is equal for all connections to set up, e.g. the number 0900 123456 or which, e.g. for the benefit of spreading connection requests in busy periods, may be different per new connection request.

The control unit Ctr further is arranged to, as soon as terminal set T1—within period p—calls, via network N1, the network address TN2 passed by the interconnection system, to detect the network address TN1 by means of “Calling Line Identification” (CLI). When period p has been expired without T1 has called, the relevant record in register R2 can be deleted, thus preventing register pollution.

The control unit Ctr is further arranged to retrieve, in the second register R2, the IP address IP2 of the second terminal, linked to the network address TN1 received—by CLI—via the non-VoIP voice network, which belongs to the terminal set T2 to which a connection is to be set up, and to establish a voice connection v2 with the second terminal set via the VoIP voice network.

The control unit Ctr, finally, is arranged to couple through the first voice connection v1 and the second voice connection v2 with each other, thus realizing the desired voice connection v1<->v2, formed by (non-VoIP) voice connection v1 and (VoIP) voice connection v2.

Users (who must have registered into register R1 in the initial phase) may keep on their telephone or PDA—the first terminal set T1—a list of buddies or users comprising (in this case) VoIP voice users—hereinabove mentioned as second terminal sets T2. When such a VoIP voice user is online, this can be called with a “press on the button”, by which IP1 (of T1) and IP2 (of T2) will be transferred to the interconnection system. Subsequently, telephone T1 calls telephone number TN2, passed by the interconnection server DS—or known beforehand, e.g. from printed documentation—and passes its own telephone number, TN1, by means of “CLI”. The interconnection system derives from the content of register R1 from TN1 the target address IP2, by which server DS is capable to interconnect the voice connection v1 (TN1<->DS via the GSM network N1) with the VoIP voice connection v2 (DS<->IP2 via the Internet N2). When the second terminal set T2 is arranged for the transfer of VoIP voice signals v2 via the VoIP voice network N2 and the first terminal set T1—not suitable for VoIP voice signals—wants to set up a connection to the second terminal set T2, the process thus goes as outlined in the preceding.

When—the other way round—the second terminal set T2 wants to set up a connection to the first terminal set T1, the process may, according to a first option, go as follows:
via an IP data connection (c) the terminal set T2 transfers—e.g. utilizing it “address book” or list of buddies or users—to the interconnection server DS its own IP address IP2 as well as the IP address IP1, belonging to the terminal set T1 to be called;
from the first register R1 the network address TN1 of that first terminal set at the non-VoIP voice network N1, belonging to the IP address IP1 of the first terminal set T1, will be retrieved
via IP data c the interconnection server DS sends a request to the first terminal set T1 to be called, to initiate, from that side, a connection with the calling second terminal set T2.

When that request—via the user of terminal set T1 or automatically, bypassing the user—is honored, subsequently a voice connection from T1 to T2 will be set up in the way explained in the preceding under Ia.

When the second terminal set T2 is arranged for the transfer of VoIP voice signals via the VoIP voice network and that second terminal set T2 desires to set up a connection to the first terminal set T1, the process according to a second option may go as follows:
via an IP data connection (c) the second terminal set T2 passes to the interconnection system DS its own IP address IP2, as well as the IP address IP1 belonging to the terminal set T1 to be called;
from the first register R1 of the interconnection server DS the network address TN1 of that first terminal set T1 at the non-VoIP voice network T1, belonging to the IP address IP1 of the first terminal set T1 to be called, is retrieved;
the interconnection server DS initiates a non-VoIP voice connection v1 via the non-VoIP voice network N1 with the relevant first terminal set T1 and a VoIP voice connection v2 via the VoIP voice network with the calling second terminal set and interconnects both voice connections (v1<->v2).

For the following there is (also) referred to FIG. 2, representing a situation in which both, the first and the second terminal set T1 and T2 are not arranged for VoIP.

Moreover, in FIG. 2 each of the terminal sets are formed by a voice terminal which is not arranged for IP (neither for VoIP, nor for IP data)—an “old fashioned” (fixed or mobile) telephone device T1a and T2a respectively—and a first and a second data terminal T1b and T2b respectively, e.g. a PC. In FIG. 2 T1a and T1b thus form together terminal set T1 and T2a and T2b form together terminal set T2.

Further, FIG. 2 represents a situation that there is a large distance between T1 and T2, e.g. that they are separated from each other by country or continent borders. In that case the interconnection system DS may have to be formed in many cases by at least two interconnection servers, i.e. one at the side of T1 and one at the side of T2.

Hereinbelow these items will be discussed in a regular order. Not all options treated in the preceding paragraph will be elaborated in detail. The most important options will be presented again in short at the end of this paragraph. The various possible embodiments are deemed to form no problem for any person skilled in the art after reading the figure descriptions.

When the second terminal set T2, just like the first terminal set T1, is arranged for non-VoIP voice signals via the non-VoIP voice network N1 (N1a and N1b respectively in FIG. 2), in other words, when neither terminal set is arranged for VoIP, according to a first option the terminal sets may be interconnected in a way as indicated below. This optional method thus is suitable for the situation that neither of both terminal sets is VoIP enabled indeed, but that both are IP data enabled and, via IP data c, can use each other's IP addresses with the help of list of buddies or users; both terminal sets, e.g., may be “state-of-the-art” GSM telephone devices which include an IP data module. The process may go as follows:
Into the first register R1 a first IP address IP1 is stored for the first terminal set T1 connected with a valid network address TN1 of that first terminal set T1 at the non-VoIP voice network N1, as well as for the second terminal set T2 a second IP address IP2 connected with a valid network address of that second terminal set T2 at the non-VoIP voice network N1;
The first terminal set T1 or the second terminal set T2 initiates a connection to the second terminal set T2 resp. first terminal set T1 (the situation is symmetrical as both terminals T1 and T2 are IP data enabled but not VoIP enabled) by performing next steps:
   via an IP data connection (c) the initiating terminal set (e.g. T1) passes to the interconnection system DS its own IP address IP1, as well as the IP address IP2 belonging to the terminal set to be called;
   from the first register R1 the network address TN1 (TN1a in FIG. 2) of the initiating terminal set at the non-VoIP voice network N1, belonging to the IP address is retrieved, as well as the network address TN1 (TN1b in FIG. 2) of the terminal set T2 at the non-VoIP voice network N1 (N1b in FIG. 2), belonging to the IP address;
   the network address TN1 of that terminal set at the non-VoIP voice network N1 retrieved in the first register R1 based on the IP address of the initiating terminal set, is stored by the interconnection server DS in a second register R2, together with the IP address IP2 of the second terminal set T2 to which a connection is desired;
   next, the first terminal set T1 calls, via the non-VoIP voice network N1, a network address TN2 at the non-VoIP voice network N1 which is valid for the interconnection server DS and at the same time passes its own network address TN1 at the non-VoIP voice network N1, which network address TN1 is passed on to the interconnection server DS by the non-VoIP voice network N1;
   the interconnection server DS retrieves in the second register R2 the network address TN1 thus received via the non-VoIP voice network N1, belonging to the IP address of the second terminal, linked to the second terminal set T2 to which a connection is desired and subsequently realizes a voice connection v with the second terminal set T2 via the first network N1 which is arranged for non-VoIP voice signals v1;
the interconnection server DS couples the first and the second voice connection v2 with each other.

When—like in the situation as described hereinabove—the second terminal set T2, just like the first terminal set T1, is arranged for non-VoIP voice signals v1 via the non-VoIP voice network N1, in other words, when neither of both terminal sets is arranged for VoIP, according to a second option the terminals may be interconnected in a way as indicated hereinbelow. This second optional method is suitable for the situation that neither of both terminal sets are VoIP enabled and that only one, only the first terminal set T1 has an own IP address; the second terminal is e.g. a somewhat older, not IP enabled GSM or a conventional POTS telephone apparatus. The process according to this second option may go as follows:
into first register R1 for the first terminal set T1 a first IP address IP1 is stored, linked with a valid network address TN1 of that first terminal set T1 at the non-VoIP voice network N1;
the first terminal set T1 initiates a connection to the second terminal set T2 by performing next steps:
   via an IP data connection (c) the first terminal set T1 passes to the interconnection system DS its own IP address IP1, as well as the network address TN1′ (TN1b in FIG. 2) of the second terminal set T2 at the non-VoIP voice network N1 (N1b in FIG. 2);
   from the first register R1 the network address is retrieved of the first terminal set T1 at the non-VoIP voice network N1, belonging to the IP address IP1;
   the network address TN1 of that terminal set T1 at the non-VoIP voice network N1, retrieved in the first register R1 based on the IP address of the first terminal set T1, is stored by the interconnection server DS into the second register R2, together with the network address TN1′ (TN1b in FIG. 2) of the second terminal set T2 at the non-VoIP voice network N1 (N1b in FIG. 2);
   next, the first terminal set T1 calls, via the non-VoIP voice network N1, a network address TN2 (TN2a in FIG. 2) at the non-VoIP voice network N1 which is valid for the interconnection server DS, and passes at the same time its own network address at the non-VoIP voice network N1, which network address is passed on to the interconnection server DS by the non-VoIP voice network N1 (“CLI”);
   the interconnection server DS retrieves in the second register R2 the network address TN1′ (TN1b in FIG. 2) of the second terminal set T2 (to be precise, the telephone number of the POTS telephone device T2a), belonging to the network address TN1a of the first terminal and received via the non-VoIP voice network N1, and subsequently realizes a voice connection v with the second terminal set T2 via the first network N1 arranged for non-VoIP voice signals v1 (in FIG. 2 formed by both for non-VoIP arranged networks—telephony networks—N1a and N1b in FIG. 2).
   the interconnection server DS (both cooperating interconnection servers DSa and DSb) couples the first and the second voice connection v2 with each other.

In the preceding always has been spoken about a first or second terminal set respectively T1 and T2 respectively. As indicated in the preceding, the first terminal set T1 or each of both terminal sets T1 and T2 may comprise a module which is arranged for non-VoIP voice signals v1—therefore not suitable for VoIP voice signals v2—, as well as a module which is suitable for IP data. For instance, the first terminal set T1 is or both terminal sets are “state-of-the-art” GSM telephone sets, not arranged for VoIP voice indeed—requiring a large bandwidth or transmission rate—but made suitable, via a built-in IP data module, for exchanging IP data (like IP addresses), thus enabling the use of lists of buddies or users etc. In this situation the module arranged for non-VoIP voice signals v1 and the module arranged for IP data therefore are physically located within the same terminal.

The first terminal set T1 or each of both terminal sets T1 and T2 may comprise a telephony terminal which is arranged for non-VoIP voice signals v1—not arranged for VoIP voice signals v2—which is neither arranged for IP data; in other words, a telephony terminal which is not arranged at all for any form of IP, e.g. an older GSM set or a conventional POTS telephone device. This deficiency, however, may—as illustrated in FIG. 2—be compensated by having the terminal set to consist of the telephone device T1a or T2a respectively, which is not arranged for IP, together with a computer terminal (“PC”) T1b or T2b respectively which is arranged for IP data. With the latter then, e.g. using a list of buddies or users installed at that PC, via IP data a voice connection between both telephone devices may be initiated which partly goes via the non-VoIP network (e.g. GSM or POTS; voice connection v1) partly via the IP network (e.g. the Internet or an Intranet; voice connection v2).

The entire connection—set up via IP data c—schematically then looks like this:

terminal T1a (non-VoIP)<->telephony network N1a (non-VoIP)<->interconnection server DSa (non-VoIP/VoIP)<->Internet N2 (VoIP)<->interconnection server DSb (VoIP/non-VoIP)<->telephony network N1b (non-VoIP)<->terminal T2a (non-VoIP).

It is noted that de interconnection server DSa and the interconnection server DSb both belong to the interconnection system mentioned in the preceding paragraph; it could be stated that both servers together form one interconnection server DS distributed over two locations. In particular when terminal T1a and terminal T2a are located geographically in the vicinity of each other, both of them may, via the same telephony network N1 make connection with the same interconnection server DS. When—as illustrated in FIG. 2—terminal T1a and terminal T2a are located at a larger geographical distance from each other, the interconnection server thus may be formed by the separate—separated physically and geographically from each other—interconnection servers DSa and DSb, which are interconnected by means of the IP data and VoIP network (the Internet).

Concerning the registers in the interconnection servers DSa and DSb, each of these interconnection servers may be provided with a first register R1a and R1b respectively and a second register R2a and R2b respectively, wherein the interconnection servers DSa and DSb are arranged to exchange, if necessary, the data written into the registers, viz. the addresses IP1, IP2, TN1a, TN1b, TN2a and TN2b, mentioned in the preceding, and their mutual relations, and in that way, like the interconnection servers DSa and DSb, will form distributed (first and second) registers.

In FIG. 2 the corresponding units, signals etc. have been labeled with “a” and “b” respectively; in the preceding text those labels have not always used for the sake of the readability.

For the sake of completeness, may be unnecessary, it is noted:
that (among others as appears from the figures) it is presumed that the IP data may be transferred via the telephony network (e.g. utilizing ADSL);
that where is spoken of a non-VoIP voice network, a network is meant which is suitable or arranged for non-VoIP voice signals, what, however, does not include that the non-VoIP voice network would be unsuitable for the transfer of VoIP voice signals; such a network—e.g. the conventional POTS telephony network—after all is, e.g. by means of ADSL etc., suitable indeed for the transfer of IP traffic, both IP data at a low bandwidth and IP traffic—including VoIP—for which a larger bandwidth is requested;
that where is spoken of a non-VoIP terminal set, a terminal set is meant—being one integral terminal or the combination of a voice terminal which is not arranged for IP and a terminal which is suitable for IP data—which is suitable for (small band) IP data indeed but not for (broadband) VoIP voice.

Finally, hereinbelow the most important options will be summarized again, which were discussed in the preceding paragraph “Summary” more in detail but could not or only partially be worked out in the exemplary embodiments.

When both terminal sets are arranged for IP data and only the second terminal set for VoIP voice signals, the IP addresses of both terminals are stored into the interconnection system: (IP1-IP2). At any moment, before or after it, the IP address of the first terminal set is stored into the interconnection server, linked to its characteristic network address: (IP1-NA1). From those combinations, (IP1-IP2) and (IP1-NA1), (NA1-IP2) is determined, viz. the characteristic network address of the first terminal set and the IP address of the second terminal set. Via IP data the interconnection system passes to the first terminal set that this must or can call the interconnection system utilizing its characteristic network address (NA1), i.e. its own network address (A-number) or a temporary and specific call number (B-number) given out by the interconnection server. The interconnection system realizes the partial voice connection with the second terminal set via the VoIP network and couples, after both partial voice connections have come about, both partial voice connections to one voice connection between the first and the second terminal set.

When both terminal sets are arranged for IP data and both for non-VoIP voice signals (both not suitable for VoIP), into the interconnection system is stored again: (IP1-IP2) and (IP1-NA1). Moreover, in this situation it will be stored into the interconnection system for the second terminal set: (IP2-NA2). Subsequently, from the data combinations (IP1-IP2),(IP1-NA1) and (IP2-NA2) will be derived: (NA1-NA2), in other words, the IP addresses of the first and second terminal set are converted into the characteristic network addresses of that first and second terminal set, after which the interconnection system realizes partial voice connections with both terminal sets, both via the/a non-VoIP network and couples both into one voice connection between the first and the second terminal set.

When only the first terminal set is suitable for IP data and both terminal sets are suitable for non-VoIP voice signals, then (e.g. going from the list of buddies or users of the first terminal set) the IP address of the first terminal set and the characteristic non-VoIP voice network address (read: telephone number) of the second terminal set will be entered: (IP1-NA2). At any moment for the first terminal set will be stored in the interconnection system (IP1-NA1), just like also in the preceding situations. From these registrations both characteristic network addresses (NA1-NA2) may be determinated and the interconnection system can pass to the first terminal set that it must or may call the interconnection system and the interconnection system can also realize the partial voice connection with the second terminal set and couple through both partial voice connections. It is noted here that for the first partial voice connection this voice connection thus is set up—invited to that via IP data by the interconnection system—starting from the first terminal set (which, in consequence, bears the costs for the connection), while in this case the second partial voice connection will have to be initiated starting from the interconnection system, after all, the connection cannot be set up—invited via IP data—from the side of the second terminal set.

In the preceding exemplary embodiments for the characteristic network address of the first or second terminal set respectively the network address of that first or second terminal set respectively at the relevant non-VoIP voice network was used, which was recognized by the interconnection system by means of CLI (Calling Line Identification). For the benefit of that CLI recognition it was desirably that the characteristic “A-number” of the first or second terminal set was transferred to the interconnection system timely, e.g. during an initial registration step.

When on the other hand as the characteristic network address of the first or second terminal set respectively a network address at the non-VoIP voice network is used which is given out as a call number (“B-number”) by the interconnection server for a certain time period to be called by the first or second terminal set respectively for realizing the first or second partial voice connection respectively, the characteristic network address may be transferred in a later stage, via IP data, to the first or second terminal set respectively, in order to be called by the first or second terminal set respectively for setting up the partial voice connection between that first or second terminal set respectively and the interconnection system. In this option it is not necessary that the characteristic network address need to be registered into the register R1, e.g. in an initial registration step, and the user of the first or second terminal set respectively even does not need to register beforehand at all—which may be an advantage when exploiting the interconnection system—as the—in this case temporary—characteristic network number is determined, by the interconnection system, “on the fly” and passed on to the relevant terminal set(s).

1. A method for setting up a voice connection between a first terminal set (T1) which is arranged for the transmission of IP based control data having a low bitrate, hereinafter indicated as IP data (c), via a connection arranged for such IP data, hereinafter indicated as IP data connection, and for the transmission of non-VoIP voice signals (v1) via a network (N1) arranged for such non-VoIP voice signals, hereinafter indicated as non-VoIP voice network, which is not arranged for voice via IP, and a second terminal set (T2) which is or is not arranged for the transmission of IP data and for the transmission of either VoIP voice signals (v2) via a network arranged for VoIP voice signals, hereinafter indicated as VoIP voice network, or non-VoIP voice signals via said non-VoIP voice network or another non-VoIP voice network, wherein, by either the first terminal set or the second terminal set a voice connection between both terminal sets is initiated using an interconnection system (DS), comprising one or more interconnection servers, which interconnection system is arranged
for exchanging IP data, relevant for setting up the voice connection between the first and second terminal set;
for setting up, by means of those IP data, a first partial voice connection between the first terminal set and the interconnection system via the non-VoIP voice network;
for setting up, by means of those IP data or not by means of those IP data, one or more further partial voice connections between the interconnection system and the second terminal set via the VoIP voice network and/or the non-VoIP voice network;
and for coupling through the first and said one or more further partial voice connections.

2. The method according to claim 1, wherein both terminal sets are arranged for IP data and only the second terminal set for VoIP voice signals, further comprising:
A). Via an IP data connection the first terminal set passes to the interconnection system its own, first IP address (IP1), as well as a second IP address (IP2), belonging to the second terminal set to be called; both IP addresses are, linked to each other, stored into the interconnection system (IP1-IP2);
B). At any moment, before, during or after the action under A), the first terminal set's IP address (IP1) is stored into the interconnection server linked to a network address (NA1) which is valid for the non-VoIP voice network and which is characteristic for that first terminal set, its characteristic network address, and both addresses are linked to each other stored into the interconnection system (IP1-NA1);
C) The characteristic non-VoIP-network address (NA1) of the first terminal set, stored in connection with the first terminal set's IP address (IP1), is stored by the interconnection system, and linked with the IP address of the second terminal set (IP2) towards which a connection is desired (NA1-IP2);
D). Via IP data the interconnection system passes to the first terminal set that the latter may call the interconnection system for effecting the first partial voice connection between the first terminal set and the interconnection system; for setting up this partial voice connection use is made of the characteristic network address (NA1) of the first terminal set;
E) The interconnection system brings about said second partial voice connection with the second terminal set via the VoIP network;
F) After both partial voice connections, viz. the one between the first terminal set and the interconnection system and the one between the second terminal set and the interconnection system, have been established, the interconnection system couples both partial voice connections to one voice connection between the first and the second terminal set.

3. The method according to claim 1, wherein both terminal sets are arranged for IP data and both for non-VoIP voice signals, further comprising:
A) Via an IP data connection the first terminal set passes to the interconnection system its own, first IP address (IP1), as well as a second IP address (IP2), belonging to the second terminal set to be called; both IP addresses are, linked to each other, stored into the interconnection system (IP1-IP2);
B). At any moment, before, during or after the action under A, the first terminal set's IP address (IP1) is stored into the interconnection server, linked to a network address (NA1) which is valid for the non-VoIP voice network and which is characteristic for that first terminal set, its characteristic network address, and both addresses are, linked to each other stored, into the interconnection system (IP1-NA1); also for the second terminal set the combination of its IP address (IP2) and a network address (NA2) which is valid for the non-VoIP voice network and which is characteristic for the second terminal set, its characteristic network address, are linked and stored into the interconnection system (IP2-NA2);
C). The characteristic non-VoIP-network address (NA1) of the first terminal set, stored in connection with the first terminal set's IP address (IP), is stored by the interconnection system, linked with the IP address of the second terminal set (IP2) towards which a connection is desired (NA1-IP2); also for the second terminal set, in the same way as for the first terminal set, from the linked data pair, IP address—characteristic network address (IP2-NA2), the IP address of the second terminal set is converted into a non-VoIP voice network address which is characteristic for that terminal set, so that the characteristic non-VoIP network address of the first terminal set can be linked, by the interconnection system, with the characteristic network address of the second terminal set (NA1-NA2);
D) Via IP data, the interconnection system passes to the first terminal set that the latter may call the interconnection system for effecting the first partial voice connection between the first terminal set and the interconnection system; for setting up this partial voice connection use being made of the characteristic network address (NA1) of the first terminal set;
E). The interconnection system brings about said second partial voice connection with the second terminal set via said or another non-VoIP voice network;
F). After both partial voice connections, viz. the one between the first terminal set and the interconnection system and the one between the second terminal set and the interconnection system, have been established, the interconnection system couples both partial voice connections to one voice connection between the first and the second terminal set.

4. The method according to claim 1, wherein only the first terminal set is arranged for IP data and both terminal sets for non-VoIP voice signals, further comprising:
A). Via an IP data connection the first terminal set passes to the interconnection system its own, first IP address (IP1), as well as a network address (NA2), which is valid for the non-VoIP voice network and which is characteristic for the second terminal set to be called, its characteristic network address; both addresses are, linked to each other, stored into the interconnection system (IP1-NA2);
B) At any moment, before, during or after the action under A), the first terminal set's IP address (IP1) is stored into the interconnection server, linked to a network address (NA1) which is valid for the non-VoIP voice network and which is characteristic for that first terminal set, its characteristic network address, and both addresses are, linked to each other stored, into the interconnection system (IP1-NA1);
C) The characteristic non-VoIP-network address (NA1) of the first terminal set, stored in connection with the first terminal set's IP address (IP1), is stored by the interconnection system, linked with the characteristic network address of the second terminal set (NA2) to which a connection is targeted (NA1-NA2);
D) Via IP data, the interconnection system passes to the first terminal set that the latter may call the interconnection system for effecting the first partial voice connection between the first terminal set and the interconnection system; for setting up this partial voice connection use is made of the characteristic network address (NA1) of the first terminal set;
E). The interconnection system brings about said second partial voice connection with the second terminal set via said or another non-VoIP voice network;
F) After both partial voice connections, viz. the one between the first terminal set and the interconnection system and the one between the second terminal set and the interconnection system, have been established, the interconnection system couples both partial voice connections to one voice connection between the first and the second terminal set.

5. The method according to claim 2, wherein the characteristic network address of the first or second terminal set respectively is the network address of the first or second terminal set respectively at the relevant non-VoIP voice network, which can be recognized by the interconnection system by means of CLI (Calling Line Identification).

6. The method according to claim 2, wherein the characteristic network address of the first or second terminal set respectively is a network address which is valid for the relevant non-VoIP voice network, which the interconnection server, at least for a certain time period, makes available as a call number which can be called by the first or second terminal set respectively for realizing the first or second partial voice connection respectively and, via IP data, passes that to the first or second terminal set respectively in order to facilitate to be called by the first or second terminal set respectively for setting up the partial voice connection between the first or second terminal set respectively and the interconnection system.

7. The method according to claim 2, wherein the second terminal set wants to set up a connection to the first terminal set, comprising the action that the second terminal set, via IP data, requests the first terminal set to set up a connection to the second terminal set; after which the connection as requested by the second terminal set, is, originating from the first terminal set, set up to the second terminal set in accordance with the actions of claim 2, using the interconnection system.

8. The method according to claim 2, wherein the second terminal set wants to set up a connection to the first terminal set, comprising the action that the second terminal set, via IP data, requests the interconnection system to set up a connection between the first and the second terminal set; after which the interconnection system sets up the requested connection in accordance with the actions of claim 2.

9. The method according to claim 1, wherein the first terminal set (T1) or each of both terminal sets comprise a module which is arranged for non-VoIP voice signals (v1) and a module which is arranged for IP data (c).

10. The method according to claim 9, wherein of the first terminal set (T1) or of each of both terminal sets the module which is arranged for non-VoIP voice signals (v1) and the module which is arranged for IP data (c) belong to a telephony terminal which is arranged for non-VoIP voice signals (v1) and for IP data (c).

11. The method according to claim 9, wherein of the second terminal set (T2) the module which is arranged for VoIP voice signals and the module which is arranged for IP data (c) is a data or telephony terminal which is arranged for VoIP voice signals and IP data (c).

12. The method according to claim 9, wherein of the first terminal set (T1) or of each of both terminal sets the module which is arranged for non-VoIP voice signals (v1) is a neither for VoIP voice signals nor for IP data (c) arranged telephony terminal and the for IP data (c) arranged module is a for IP data (c) arranged data terminal.

13. (canceled)

14. The method according to claim 3, wherein the characteristic network address of the first or second terminal set respectively is the network address of the first or second terminal set respectively at the relevant non-VoIP voice network, which can be recognized by the interconnection system by means of CLI (Calling Line Identification).

15. The method according to claim 4, wherein the characteristic network address of the first or second terminal set respectively is the network address of the first or second terminal set respectively at the relevant non-VoIP voice network, which can be recognized by the interconnection system by means of CLI (Calling Line Identification).

16. The method according to claim 3, wherein the characteristic network address of the first or second terminal set respectively is a network address which is valid for the relevant non-VoIP voice network, which the interconnection server, at least for a certain time period, makes available as a call number which can be called by the first or second terminal set respectively for realizing the first or second partial voice connection respectively and, via IP data, passes that to the first or second terminal set respectively in order to facilitate to be called by the first or second terminal set respectively for setting up the partial voice connection between the first or second terminal set respectively and the interconnection system.

17. The method according to claim 4, wherein the characteristic network address of the first or second terminal set respectively is a network address which is valid for the relevant non-VoIP voice network, which the interconnection server, at least for a certain time period, makes available as a call number which can be called by the first or second terminal set respectively for realizing the first or second partial voice connection respectively and, via IP data, passes that to the first or second terminal set respectively in order to facilitate to be called by the first or second terminal set respectively for setting up the partial voice connection between the first or second terminal set respectively and the interconnection system.

18. A system for setting up a voice connection between a first terminal set (T1) which is arranged for the transmission of IP based control data having a low bitrate, hereinafter indicated as IP data (c), via a connection arranged for such IP data, hereinafter indicated as IP data connection, and for the transmission of non-VoIP voice signals (v1) via a network (N1) arranged for such non-VoIP voice signals, hereinafter indicated as non-VoIP voice network, which is not arranged for voice via IP, and a second terminal set (T2) which is or is not arranged for the transmission of IP data and for the transmission of either VoIP voice signals (v2) via a network arranged for VoIP voice signals, hereinafter indicated as VoIP voice network,
